(19) United States
(12) Patent Application Publication
(10) Pub. No.: US 2018/0355580 A1
(43) Pub. Date: Dec. 13, 2018

(54) QUICK-CHANGE DEVICE

(71) Applicant: LEHNHOFF HARTSTAHL GMBH, Baden-Baden (DE)

(72) Inventor: PETER-ALEXANDER LEHNHOFF, BUEHL (DE)

(73) Assignee: LEHNHOFF HARTSTAHL GMBH, BADEN-BADEN (DE)

(21) Appl. No.: 15/735,565

(22) PCT Filed: Jun. 10, 2016
(86) PCT No.: PCT/EP2016/063350

§ 371 Date: Dec. 11, 2017

(30) Foreign Application Priority Data
Jun. 12, 2015 (DE) 102015210857.0

(51) Int. Cl. E02F 3/36; F16B 2/12

(52) U.S. Cl. CPC E02F 3/3613; F16B 2/12; E02F 3/3663; E02F 3/3627; E02F 3/3622

(57) ABSTRACT

A quick-change device (12) comprising a receiving structure (22, 30) having an abutment (24, 32) having a bearing region (36), which is circular arc-shaped in section, with a housing radius (Ra) about a centre point (Ma) through which the circle centre point axis (A) extends, wherein furthermore the receiving structure (22, 30) comprises a locking bolt (26, 34) which has a planar clamping surface (38), wherein, the locking bolt (26, 34) has a movement direction (VR) which is situated in the orthogonal direction to the circle centre point axis (A), wherein the clamping surface angle (B) with the movement direction (VR), with the result that a cylindrical locking pin (16, 40) can be brought into contact between the clamping surface (38) and the bearing region (36).

This patent application is the national phase entry of PCT/EP2016/063350, international application filing date Jun. 10, 2016, which claims the benefit and priority of and to German patent application no. 10 2015 210 857.0 filed Jun. 12, 2015.

PCT/EP2016/063350, international application filing date Jun. 10, 2016 and German patent application no. 10 2015 210 857.0 filed Jun. 12, 2015 are incorporated herein by reference hereto in their entireties.

The invention relates to a quick-change device.

A generic quick-change device as well as a quick-chance unit are known from WO 2011/019312 A1.

The above specification discloses a quick-change device which, on one side thereof, engages around a first locking pin of an adapter by means of a semicircular claw, wherein a receiving structure comprising a quarter circle-shaped section, which serves as an abutment, is provided for fixing the second locking pin which is parallel to the first locking pin, with two axially movable locking bolts together with the abutment forming a form-fitting and force-locking connection to the locking pin.

After a prolonged period of use, such an arrangement leads to the abutment becoming worn out, thus subjecting the form-fitting connection to backlash, which in turn favors progressive wear of the abutment.

Additional quick-change units are disclosed in US 2002/0071 754 A1, U.S. Pat. No. 5,179,794 A, WO 2006/083 172 A, WO 2011/019 312 A1, WO 2012/125 104 A1 and WO 2014/168 540 A1. These prior art quick-change units are also subject to backlash. Such backlash increases due to wear, in particular after prolonged use. As a result, the interaction of adapter and quick-change device likewise favors progressive wear of the abutment.

It is the object of the invention to develop a quick-change device which ensures backlash-free coupling of the locking bolt to the locking pins of an adapter, and thus of the quick-change device to its adapter, over a prolonged period of time.

As is known, a quick-change device comprises a receiving structure having an abutment having a bearing surface which is circular arc-shaped in section, with a housing radius R_{G} about a center point M_{G} through which the circle center point axis extends. The receiving structure furthermore comprises a locking bolt which has a planar clamping surface, wherein the locking bolt has a movement direction which is situated in the orthogonal direction to the circle center point axis, wherein the clamping surface encloses an acute clamping surface angle β with the movement direction. The circle center point axis is the axis which is normal to the circular surface and which extends through the center point. Along the movement direction, the locking bolt can be moved in the locking direction and thus into a “locked” position, and it can be moved in the opposite, i.e. the unlocking, direction and thus into the “open” position. The bearing surface, and thus the circular arc shape, extends over at least a bearing angle range α_{B} with respect to the movement direction, wherein the bearing angle α changes in dependence on the position of a locking pin on the clamping surface. The clamping surface has an upper bearing level and a lower bearing level, which can be brought into contact with the locking pin in dependence on the movement path, with an intermediate bearing level lying between the upper bearing level and the lower bearing level. The distance of an intermediate level on the clamping surface from the parallel of the movement direction through the circle center point axis of the center point is situated in a range between

Bₘᵢₙ(R_{G})=R_{G}*(V*cos(β)−((1−V)*sin(α=45°))) with Vₘᵢₙ=0.75, and

Bₘₐₓ(R_{G})=R_{G}*(V*cos(β)−((1−V)*sin(α=45°))) with Vₘₐₓ=0.85,

wherein the variable V lies between Vₘᵢₙ=0.75 for the minimum range level Bₘᵢₙ and Vₘₐₓ=0.85 for the maximum range level Bₘₐₓ, wherein an upper bearing level is situated between the parallel of the movement direction through the circle center point axis and the intermediate level, with Bₘᵢₙ and Bₘₐₓ being the distance B from this parallel. Furthermore, the locking bolt is movable in such a way that the intermediate level can be brought into a region between the tangent, which is orthogonal to the movement direction, to a circle about the center point M_{G} with the radius R_{G}, and the parallel P_{T} to the tangent through the center point M_{G}. The variable V is obtained from the ratio V=R_{A}/R_{G}, where R_{A}<R_{G} and thus V<1.

This embodiment allows a locking pin having a radius R_{A} of V*R_{G} to be held in a force-locking and form-fitting manner. When the abutment or the opposite claws start to wear out, the locking pin moves along the bearing surface in the circular arc-shaped region, with the bearing angle a increasing progressively. The abovementioned design results in the locking pin making linear contact with the clamping surface and making linear contact with the bearing surface of the abutment. As the movement path of the locking bolt increases in the locking direction, the line of contact of the locking pin on the locking bolt shifts towards the upper bearing level. A force-locking and form-fitting connection can thus be obtained which can be “re-adjusted”. For locking pins which have a cylindrically shaped receiving area, this guarantees long-term backlash-free mounting even when claws and abutments become worn out—which significantly increases the service lives of all the relevant bearing surfaces and thus of the quick-change device itself.

In a particularly preferred embodiment of the invention, the clamping surface angle β is in a range from (and including) 7° to (and including) 13°. Preferably, the clamping surface angle is 10°. The angle is thus in a range which is just over the self-locking range, which is influenced by the materials and the surface characteristics of the cooperating areas of the locking pin and the clamping surface.

For automatically re-adjusting the locking pin, the latter can be preloaded in the movement direction. Such preload is in particular achieved by means of a spring.

In yet another advantageous embodiment, the circular arc-shaped region of the abutment can extend at least over a sector of between 30° and 60° with respect to the movement direction of the locking bolt. The quick-change device may preferably be designed such that the clamping surface angle β and the variable V are matched to one another in such a way that an upper bearing level is obtained at a bearing angle α_{O}=60° and a lower bearing level is obtained at an angle α_{U}=30°. This angular range results in a particularly favorable introduction of force, which makes it possible to introduce stresses resulting from the digging and lifting forces of the carrier machine into the quick-change device in an optimal way.

Preferably, the quick-change device can comprise a second receiving structure having a circular arc-shaped region having a housing radius R_{G2}, with R_{G}*Vₘᵢₙ|Vₘᵢₙ=0.75≤R_{G2}≤R_{G}*Vₘₐₓ|Vₘₐₓ=0.85. The circular arc-shaped region is obtained around a center point M_{G2}.

This receiving structure is particularly suitable for receiving a symmetrical adapter in which both locking pins of the adapter have the same diameter, at least in the receiving area. The second receiving structure may preferably be formed as a claw whose circular arc-shaped portion extends at least over one third of a periphery of a circle, which corresponds to an angle σ. The line connecting the center points M_{G2}, M_{G1}, together with the movement direction of the locking bolt, encloses an angle γ of less than ±10°, in particular of less than ±5°, or is parallel. This creates a flat structure in which the forces can be absorbed ideally, since the tensile forces exerted on the locking bolt in particular during operation can be supported in a form-fitting manner on its guide, in particular orthogonally to the movement direction.

More specifically, the quick-change device comprises two inventive receiving structures which extend coaxially along the circle center point axis, with the width and shape of the bearing region of each receiving structure being chosen depending on the stress to be expected and each bearing region extending over at least one fourth of the total width of the quick-change device.

On the side of the clamping surface facing away from the drive of the locking bolt, the locking bolt can have a planar surface 39 which is parallel to the movement direction. In this region, a purely form-fitting secondary bearing can thus be provided which is adapted to hold the locking pin therein even if there is a relative force acting between the adapter and the quick-change device, which force exceeds the intended use and thus results in the locking bolt being returned.

In another aspect thereof, the invention relates to a quick-change unit comprising a quick-change device and an adapter. The adapter has two parallel locking pins. The quick-change device comprises a coupling claw associated with a first locking pin of a radius R_{A1} and a locking bolt associated with the second locking pin of a radius R_{A2}, which bolt is slidably guided along a movement direction, said locking bolt cooperating with an abutment in such a way that the second locking pin can be introduced between the locking pin and the adapter in a form-fitting and force-locking manner, at least in the region of the locking bolt and the abutment of the locking pin of the adapter.

According to the invention, the locking bolt has a planar clamping surface (planar here meaning flat, not curved), on which the locking bolt clamps the second locking pin to the abutment, which clamping surface is inclined at a clamping surface angle β relative to the movement direction.

In an advantageous embodiment of the invention, the abutment of the quick-change device has a concave contour with a radius of 1.17*R_{A2}≤R_{G}≤1.33*R_{A2}. Consequently, fixing the second locking pin can be achieved in that the clamping can be re-adjusted by means of the locking pin, should the abutment and/or the claw become worn out, thus still securing it in a backlash-free, force-locking and form-fitting manner.

More specifically, the adapter is in the form of a symmetrical adapter, with the locking pins of the adapter being identical in diameter and thus also in radius, i.e. R_{A1}=R_{A2}. A quick-change device of such dimensions is referred to as a symmetrical quick-change device because it is capable of reliably engaging the adapter without play in a form-fitting and force-locking manner in two opposite orientations which are offset by 180°.

In an advantageous embodiment, the clamping surface angle β can be in a range of between 7° and 13°, in particular it can be 10°. Consequently, when using conventional materials, the quick-change device is matched thereto such that the transition from the clamping surface to the locking pin is just above the self-locking range.

In yet another advantageous embodiment, the quick-change device comprises a receiving structure of the abovementioned type.

Additional advantages, features and possible applications of the present invention may be gathered from the description which follows, and by reference to the embodiments illustrated in the drawings.

Throughout the description, the claims and the drawings, those reference characters are used as are listed in the List of Reference Characters below. In the drawings,

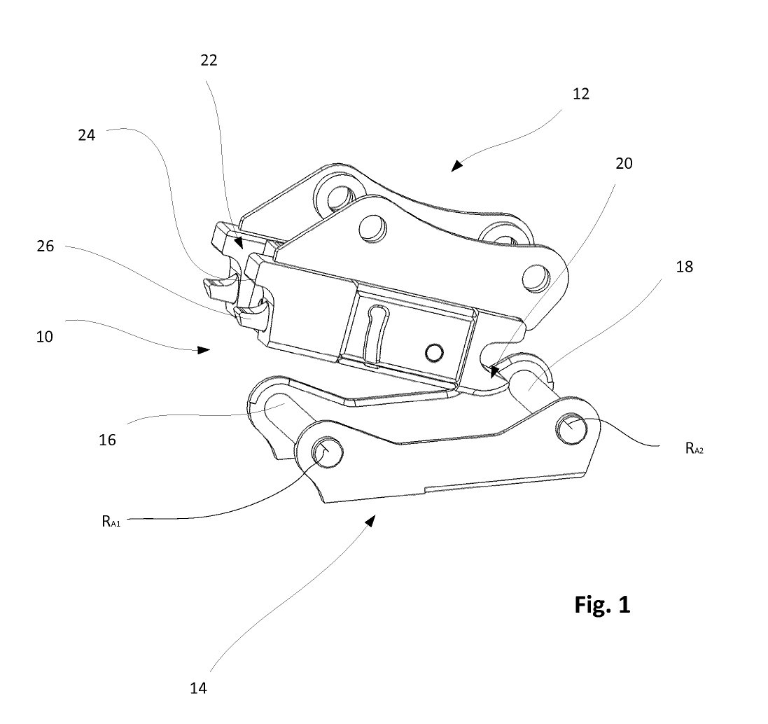

FIG. 1 is a perspective view of a quick-change unit;

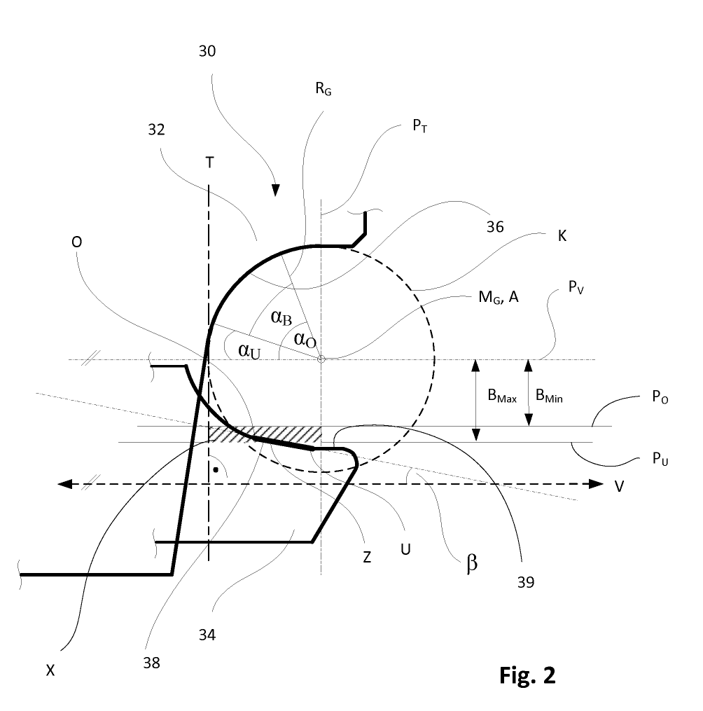

FIG. 2 is a schematic view of a receiving structure;

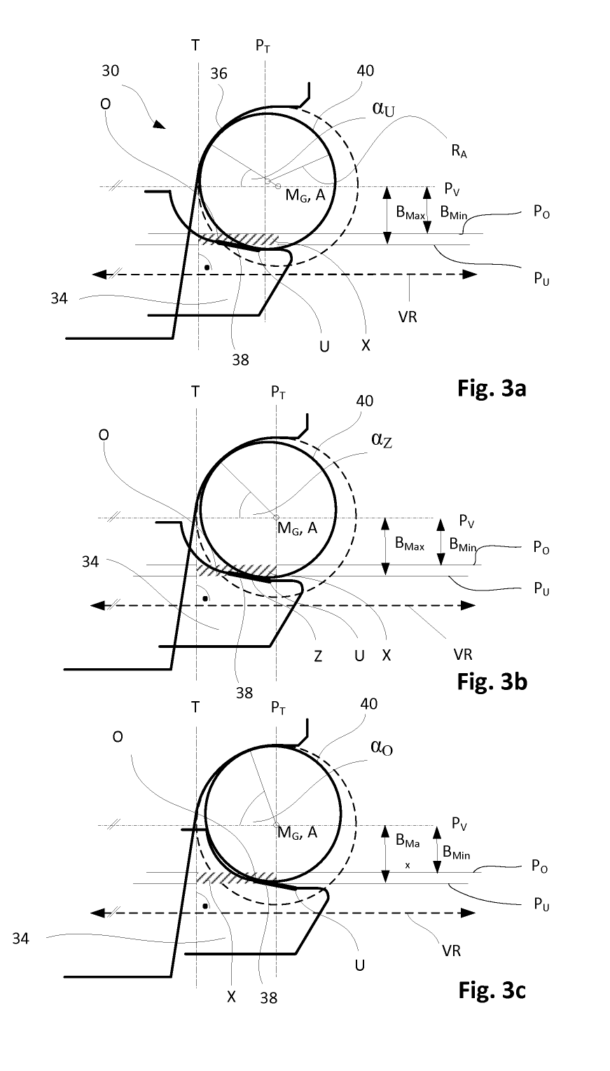

FIG. 3a is a schematic view of a receiving structure which is not worn out;

FIG. 3b is a schematic view of a receiving structure which is somewhat worn out;

FIG. 3c is a schematic view of a receiving structure which is in a borderline worn condition; and

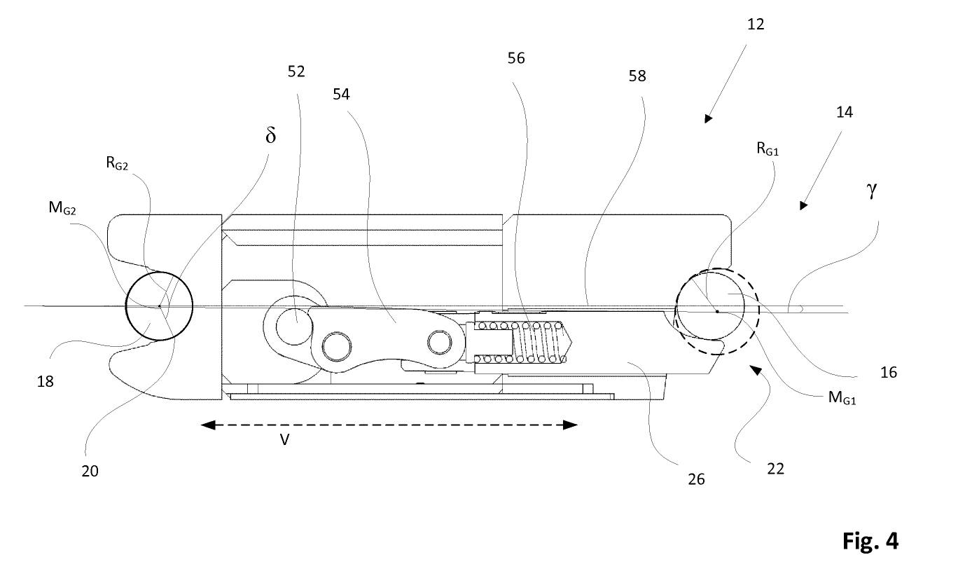

FIG. 4 is a sectional view of the symmetrical quick-change device of FIG. 1 with the adapter inserted therein, in a locked state thereof.

FIG. 1 is a perspective view of a quick-change unit 10 comprising a quick-change device 12 and an adapter 14, which is regularly fastened to a working tool.

The adapter 14 has two parallel locking pins 16, 18 around which the quick-change device 12 engages for operation. For this purpose, the quick-change device 12 has at least one receiving structure 20, 22 associated with a locking pin 16, 18 each. In the quick-change device 12 shown in FIG. 1, a first receiving structure 20 is formed as a so-called claw coupling which closely engages around a first locking pin 18. A second receiving structure 22 is adapted to lock a locking pin 16 between an abutment 24 and a movable locking bolt 26. The way the abutment 24 and the locking bolt 26 are matched to one another will be explained in more detail with reference to the following Figures. The diameter of the at least partially cylindrical locking pin 16, and thus the radius R_{A1}, and the diameter of the at least partially cylindrically locking pin 18, and thus the radius R_{A2}, are identical.

FIG. 2 is a schematic view of a receiving structure 30 comprising an abutment 32 and a locking bolt 34 which latter can be moved into the movement direction VR indicated. The abutment 32 has a bearing region 36 which is circular arc-shaped in section with a radius R_{G}around the center point M_{G}, through which a center point axis A of a circle K of a radius R_{G} and the center point M_{G} extends. The circular arc-shaped bearing region 36 extends over an angle α_{B}, at least over a sector of between 30° and 60°, with respect to the movement direction VR of the locking bolt 34.

The locking bolt 34 has a planar clamping surface 38 (planar here meaning flat, i.e. not curved), which is inclined at an acute angle β with respect to the movement direction VR. The clamping surface 38 has an upper bearing level O and a lower bearing level U. Between the upper bearing level O and the lower bearing level U there is an intermediate bearing level Z. The clamping surface 38 is arranged such that it can be brought [in the region] between the tangent T, which is orthogonal to the movement direction VR, on the circle K around the center point M_{G} having the radius R_{G}, and the parallel P_{T} to the tangent T through the center point M_{G}. The intermediate level Z is in a region X which extends in a first direction which is spaced at a distance B of Bₘᵢₙ≤B≤Bₘₐₓ from the parallel P_{V} of the movement direction VR through the center point M_{G}, i.e. between a parallel P_{O} of the movement direction VR, which forms the upper distance Bₘᵢₙ, and a parallel P_{U} of the movement direction VR, which forms the lower distance Bₘₐₓ, i.e. between P_{V} and P_{O} on the one side and between P_{V} and P_{U} on the other.

For the extent of the region X in the first direction for the potential intermediate level Z between Bₘᵢₙ and Bₘₐₓ, the following applies for Bₘᵢₙ and Bₘₐₓ:

Bₘᵢₙ(R_{G})=R_{G}*(V*cos(β)−((1−V)*sin(α=45°))) with Vₘᵢₙ=0.75, and

Bₘₐₓ(R_{G})=R_{G}*(V*cos(β)−((1−V)*sin(α=45°))) with Vₘₐₓ=0.85.

The variable V is between Vₘᵢₙ=0.75 for the minimum range level Bₘᵢₙ and Vₘₐₓ=0.85 for the maximum range level Bₘₐₓ. In the present case, the clamping surface angle β is 10°. In the locked state of a respective locking pin, a contact line results depending on the degree of wear of the abutment or the locking pin in the region α_{B}. The circular arc-shaped bearing region 36 extends at least over this region which in the present case is between 30° and 60° relative to the movement direction VR.

A second direction, which is orthogonal to the extent of the region X in the first direction, for the possible intermediate level Z is formed by the tangent T, which is orthogonal to the movement direction VR, to a circle around the center point M_{G} having a radius R_{G}, on the one side, and by the parallel P_{T} to the tangent T through the center point M_{B}, on the other side.

The region X into which an intermediate level Z can be introduced is indicated by hatching.

The clamping surface angle β and the variable V are matched to one other in such a way that an upper bearing level is obtained for a bearing angle α_{O}=60° and a lower bearing level is obtained for a bearing angle α_{U}=30°. This angular range yields a particularly favorable introduction of force which makes it possible to introduce stresses resulting from the digging and lifting forces of the carrier machine into the quick-change device in an optimal manner.

On the side of the clamping surface 38 which faces away from a drive of the locking bolt 34, the locking bolt 34 has a planar surface 39 which is parallel to the movement direction VR. In this area, a purely form-fitting secondary bearing will thus be provided in which a locking pin can be form-fittingly held when there is a relative force acting between the adapter 14 and the quick-change device 12 which exceeds the intended use and thus causes the locking bolt 34 to be returned.

The different positions which a locking pin can assume relative to the receiving structure 30 are illustrated in more detail in FIGS. 3a to 3c.

FIG. 3a is a schematic view of a receiving structure 30 which is new and thus not worn out. Held in the receiving structure 30 is a locking pin 40 of a radius R_{A}. The locking pin 40 rests against the clamping surface 38 at a lower bearing level U. Consequently, a contact line results for the locking pin 40 on the bearing surface 36 at an angle of approx. α_{U}=30°.

FIG. 3b is a schematic view of a receiving structure 30 which is somewhat worn out. The locking pin 40 now rests against the clamping surface 38 of the locking bolt 34 at an intermediate level Z. In this condition, the locking pin 40 rests against the bearing surface 36 on a contact line, thus yielding a bearing angle of approx. α_{U}=45° relative to the parallel P_{V}.

FIG. 3c is a schematic view of a receiving structure 30 of a borderline worn-out condition. Here, the locking pin 40 rests against the clamping surface 38 at the upper bearing level O. The resulting bearing angle relative to the contact line is approx. α_{O}=65°. It becomes clear from the views of FIGS. 3a to 3c that this makes it possible to lock the locking pin 40 in a force-locking and form-fitting manner without play over a considerable range of wear.

FIG. 4 is a sectional view of the symmetrical quick-change device 12 of FIG. 1 with the adapter inserted therein, in a locked state thereof, which device comprises an inventive receiving structure 22 similar to the receiving structure 30 of FIG. 2, for detachably fixing a first locking pin 18. Moreover, the quick-change device 12 comprises a second receiving structure 20 which engages around a second locking pin 18 in the manner of a claw. The locking pins 16, 18 have the same radius R_{A}. The second receiving structure 20 has a circular arc-shaped region over the center point angle σ whose radius R_{G2} is about equal to the radius R_{A2} of the locking pin 18.

The inventive receiving structure 22 has a contour which is circular arc-shaped in section with a radius R_{G1}. The locking pin 16 is locked using a locking bolt 26 of the aforementioned design, for which purpose a drive 52, in particular a hydraulic rotary drive, is provided which is adapted to move the locking bolt 26 in the movement direction VR. In the present embodiment, the locking bolt 26 is articulated on the drive via a so-called toggle-lever mechanism 54. Moreover, the locking bolt 26 is preloaded in the movement direction VR by a spring 56. This preload amongst others acts to retain the locking pin 16 in a force-locking manner. The locking bolt 26 is form-fittingly supported in a sliding sleeve 58 in a direction orthogonal to the movement direction VR, which allows forces introduced in this direction to be optimally absorbed. In the present case, the line connecting the center points M_{G1} and M_{G2} encloses an angle γ of approx. 1° with the parallel P_{V} to the movement direction VR through the center point M_{G2}. This allows forces which regularly act in the digging direction to be optimally absorbed. The invention thus provides an ideally adapted receiving means for an adapter, in particular also for a symmetrical adapter.

### LIST OF REFERENCE CHARACTERS

10 quick-change unit
12 quick-change device
14 adapter
16 locking pin
18 locking pin
20 receiving structure
22 receiving structure
24 abutment
26 locking bolt
30 receiving structure
32 abutment
34 locking bolt
36 bearing region
38 clamping surface
39 planar surface
40 locking pin
42 quick-change device
52 drive
54 toggle-lever mechanism
56 spring
58 sliding sleeve
α_{B} bearing angle range
α bearing angle
α_{O} bearing angle of the upper bearing level O
α_{U} bearing angle of the lower bearing level U
α_{Z} bearing angle of the intermediate level Z
β clamping surface angle
γ angle which encloses the line, which interconnects the center points M_{G1} and M_{G2}, with the parallel P_{V} to the movement direction VR through the center point M_{G2}
σ angle of the circular arc-shaped section of the second receiving structure 20
A circle center axis through the center point M_{G}
B distance from P_{V}
Bₘᵢₙ(R_{G}) distance between the straight lines P_{V} and P_{O}
Bₘₐₓ(R_{G}) distance between the straight lines P_{V} and P_{U}
K circle
P_{T} parallel to the tangent
M_{G} center point of circle K
O upper bearing level
P_{V} parallel P_{V} to the movement direction VR through the center point M_{G}
R_{A} radius of the locking pin 40
R_{A1} radius of the adapter locking pin
R_{A2} radius of the adapter locking pin
R_{G} housing radius
T tangent
U lower bearing level
V variable, ratio R_{G} to R_{A}
Vₘᵢₙ variable
Vₘₐₓ variable
VR movement direction
X region between the straight line P_{V} and a parallel P_{T}—extent of the region X in a second direction—as well as P_{V} and P_{O}, or P_{U} resp.,—extent of the region X in a first direction
Z intermediate level

1-11. (canceled)

12. Quick-change device (12) comprising:
a receiving structure (22, 30) having an abutment (24, 32);
said abutment (24, 32) having a bearing region (36);
said bearing region circular arc-shaped in section, with a housing radius (R_{G}) about a center point (M_{G}) through which the circle center point axis (A) extends;
said receiving structure (22, 30) comprises a locking bolt (26, 34) which has a planar clamping surface (38);
said locking bolt (26, 34) has a movement direction (VR) which is situated in the orthogonal direction to the circle center point axis (A);
said planar clamping surface (38) encloses an acute clamping surface angle (β) with the movement direction (VR) such that a cylindrical locking pin (16, 18, 40) can be brought into contact between said clamping surface (38) and said bearing region (36);
said bearing region (36) extends at least over a bearing angle range (αB) with respect to the movement direction (VR);
said bearing angle (α) changes in dependence on the position of a locking pin (16, 18, 40) at the clamping surface (38);
the distance of an intermediate level (Z) on the clamping surface (38) from the parallel (P_{V}) of the movement direction (VR) through the circle center point axis (A) of the center point (M_{G}) is situated in a range (X) between
Bₘᵢₙ(R_{G})=R_{G}*(V*cos(β)−((1−V)*sin(α=45°)))|Vₘᵢₙ=0.75, and
Bₘₐₓ(R_{G})=R_{G}*(V*cos(β)−((1−V)*sin(α=45°)))|Vₘₐₓ=0.85.
wherein the variable V lies between Vₘᵢₙ=0.75 for the minimum range level Bₘᵢₙ and Vₘₐₓ=0.85 for the maximum range level Bₘₐₓ;
said clamping surface (38) has an upper bearing level (O) and a lower bearing level (U) which can be brought into contact with the locking pin (16, 18, 40) in dependence on the movement path;
said upper bearing level (O) is situated between the parallel (P_{V}) of the movement direction (VR) and the intermediate level (Z);
said locking bolt (26, 34) is movable in such a way that the intermediate level (Z) can be brought into the region (X) between the tangent (T), which is orthogonal to the movement direction (VR), to a circle about the center point (M_{G}) with the radius (R_{G}) and the parallel (P_{T}) to the tangent (T) through the center point (M_{G}), with the variable V being obtained from the ratio V=R_{A}/R_{G}, where R_{A}<R_{G} and thus always V<1.

13. Quick-change device according to claim 12, further comprising:
said clamping surface (38) has a clamping surface angle (β) in the range of between 7° and 13°.

14. Quick-change device according to claim 12, further comprising:
said clamping surface angle (β) and said variable (V) are matched to one other in such a way that an upper bearing level is obtained for a bearing angle α_{O}=60° and a lower bearing level is obtained for a bearing angle α_{U}=30°.

15. Quick-change device according to claim 12, further comprising:
said locking bolt (26, 34) is preloaded in said movement direction (VR).

16. Quick-change device according to claim 12, further comprising:
a second receiving structure (22, 30) has a circular arc-shaped area with a housing radius (R_{G}), with R_{G}*Vₘᵢₙ|Vₘᵢₙ=0.75≤R_{G2}≤R_{G}*Vₘₐₓ|Vₘₐₓ=0.85.

17. Quick-change device according to claim 16, further comprising:
said second receiving structure (22, 30) is in the form of a claw, said claw includes a circular arc-shaped area, over at least one third of the circular arc-shaped area, extends with the housing radius (R_{G2}) (angle σ).

18. Quick-change unit (10), comprising:
a quick-change device (12) and an adapter (14);
said adapter (14) has first and second parallel locking pins (16, 18, 40);
said quick-change device (12) has a coupling claw associated with said first locking pin (16, 18, 40) of a radius R_{A1} of said adapter (14) and a locking bolt (26, 34) associated with said second locking pin (16, 18, 40) of a radius R_{A2} and movably guided along a movement direction (VR);
said second locking pin cooperates with an abutment (24, 32) such that said second locking pin (16,18,40) can be form-fittingly introduced between at least said bearing region (36) of said locking bolt (26, 34) and said abutment (24, 32) of said locking pin (16, 18, 40) of said adapter (14), said locking pin (16, 18, 40) and said adapter (14);
said locking bolt (26, 34) has a planar clamping surface (38) on which said locking bolt (26, 34) clamps said second locking pin (16, 18, 40) to said abutment (24, 32); and,
said clamping surface (38) is inclined at a clamping surface angle (β) relative to the movement direction (VR).

19. Quick-change unit according to claim 18, further comprising:
said abutment (24, 32) of said quick-change device (12) has a concave circular contour of a radius R_{G}, wherein 1.17*R_{A2}≤R_{G}≤1.33*R_{A2}.

20. Quick-change unit according to claim 18, further comprising:
said locking bolts (16, 18, 40) of said adapter (14) are identical in diameter (radius R_{A1}=R_{A2}).

21. Quick-change unit according to claim 18, further comprising:
said clamping surface angle (β) is in the range of between 7° and 13°.

22. Quick-change unit according to claim 18 in combination with a quick-change device (12), said quick change device comprising:
a receiving structure (22, 30) having an abutment (24, 32);
said abutment (24, 32) having a bearing region (36);
said bearing region circular arc-shaped in section, with a housing radius (R_{G}) about a center point (M_{G}) through which the circle center point axis (A) extends;
said receiving structure (22, 30) comprises a locking bolt (26, 34) which has a planar clamping surface (38);
said locking bolt (26, 34) has a movement direction (VR) which is situated in the orthogonal direction to the circle center point axis (A);
said planar clamping surface (38) encloses an acute clamping surface angle (β) with the movement direction (VR) such that a cylindrical locking pin (16, 18, 40) can be brought into contact between said clamping surface (38) and said bearing region (36);
said bearing region (36) extends at least over a bearing angle range (αB) with respect to the movement direction (VR);
said bearing angle (α) changes in dependence on the position of a locking pin (16, 18, 40) at the clamping surface (38);
the distance of an intermediate level (Z) on the clamping surface (38) from the parallel (P_{V}) of the movement direction (VR) through the circle center point axis (A) of the center point (M_{G}) is situated in a range (X) between
Bₘᵢₙ(R_{G})=R_{G}*(V*cos(β)−((1−V)*sin(α=45°)))|Vₘᵢₙ=0.75, and
Bₘₐₓ(R_{G})=R_{G}*(V*cos(β)−((1−V)*sin(α=45°)))|Vₘₐₓ=0.85.
wherein the variable V lies between Vₘᵢₙ=0.75 for the minimum range level Bₘᵢₙ and Vₘₐₓ=0.85 for the maximum range level Bₘₐₓ;
said clamping surface (38) has an upper bearing level (O) and a lower bearing level (U) which can be brought into contact with the locking pin (16, 18, 40) in dependence on the movement path;
said upper bearing level (O) is situated between the parallel (P_{V}) of the movement direction (VR) and the intermediate level (Z);
said locking bolt (26, 34) is movable in such a way that the intermediate level (Z) can be brought into the region (X) between the tangent (T), which is orthogonal to the movement direction (VR), to a circle about the center point (M_{G}) with the radius (R_{G}) and the parallel (P_{T}) to the tangent (T) through the center point (M_{G}), with the variable V being obtained from the ratio V=R_{A}/R_{G}, where R_{A}<R_{G} and thus always V<1.
